(19) United States
(12) Patent Application Publication
(10) Pub. No.: US 2018/0009120 A1
(43) Pub. Date: Jan. 11, 2018

(54) CLIP FOR BAG PACKAGES

(71) Applicant: ARIEL LEIBOVITCH, Herzlia (IL)

(72) Inventor: ARIEL LEIBOVITCH, Herzlia (IL)

(73) Assignee: Ariel LEIBOVITCH, Herzlia (IL)

(21) Appl. No.: 15/546,046

(22) PCT Filed: Feb. 7, 2016
(86) PCT No.: PCT/IL2016/050141

§ 371 Date: Jul. 25, 2017

Related U.S. Application Data
(60) Provisional application No. 62/113,531, filed on Feb. 9, 2015.

(51) Int. Cl. B26B 11/00; B65D 33/16; B26B 5/00

(52) U.S. Cl. CPC B26B 11/00; B26B 5/00; B65D 33/1675

(57) ABSTRACT

The present invention relates to a cutter clip for closing a bag package, said clip comprising: (a) a first arm having a clipping hook, at the front end, thereof; (b) a second arm, connected at its back side to the back side of said first arm, having a closing hook, at its front end, thereof, wherein said clipping hook closes on said closing hook, when said clip is in a closed position, for closing said bag package; (c) a cutting slot formed within said clip; and (d) a cutting blade, mounted within said cutting slot.

### TECHNICAL FIELD

The present invention relates to clips for bag-type packages.

### BACKGROUND

Many processed food and other products come packaged in bags which are sealed tightly with adhesives. Since the adhesives used to seal the bag packages are quite strong and cannot be pulled apart by hand, frequently the consumer tears the bag while opening it. As a result, many families nowadays store a pair of scissors in the kitchen to open such bag packages.

Moreover, many families keep clips on hand to seal such bag packages after they have been opened. Two types of clips exist, one which uses a spring to force its two opposing arms against the bag, and one which uses a hook-type mechanism to clip its two opposing arms against the bag. Existing hook-type clips have integral hinges that are especially thin-walled to provide the flexibility needed for opening and closing the clip. Unfortunately, over time, clips are prone to breaking in this area.

It would therefore be desired to propose a system void of these deficiencies.

### SUMMARY

It is an object of the present invention to provide a clip for sealing packages that also has cutting means for opening a bag package.

It is another object of the present invention to provide a clip that has an enforced hinge for sealing packages which is durable and flexible.

It is yet another object of the present invention to provide a clip that has reduced defects in manufacturing.

Other objects and advantages of the invention will become apparent as the description proceeds.

The present invention relates to a cutter clip for closing a bag package, said clip comprising: (a) a first arm having a clipping hook, at the front end, thereof; (b) a second arm, connected at its back side to the back side of said first arm, having a closing hook, at its front end, thereof, wherein said clipping hook closes on said closing hook, when said clip is in a closed position, for closing said bag package; (c) a cutting slot formed within said clip; and (d) a cutting blade, mounted within said cutting slot.

Preferably, an integral bow connects the back ends of the first and second arms along their outer walls.

Preferably, the bow has a thickness in the range of between 0.5-5 mm.

In one embodiment, the bow is a smooth bow.

In one embodiment, the bow is a ridged bow.

In one embodiment, a hinge connects the back ends of said first and second arms.

In one embodiment, two hinges connect the back ends of said first and second arms.

In one embodiment, the clipping hook, of the first arm, covers the blade when the hook is in the closed position.

In one embodiment, the cutting blade is installed within a blade station.

In one embodiment, plastic may be injected directly onto the metal of the blade before the blade is placed into the blade station.

In one embodiment, the blade station may be over molded around blade.

In one embodiment, the clip may be manufactured with over molding, by injecting the plastic of the clip around the blade.

In one embodiment, the blade is removable.

In one embodiment, the blade is a utility knife type of blade.

In one embodiment, the blade is located on the first arm.

In one embodiment, the blade is located on the second arm

In one embodiment, at least one of the arms, has a hole therewithin.

### BRIEF DESCRIPTION OF THE DRAWINGS

The accompanying drawings, and specific references to their details, are herein used, by way of example only, to illustratively describe some of the embodiments of the invention.

In the drawings:

FIG. 1A is a schematic illustration of a cutter clip, constructed and operative in accordance with the present invention, in an open position and a close up view of a portion of the cutter clip having a blade;

FIG. 1B is a schematic illustration of a person opening a bag package using the cutter clip of FIG. 1A;

FIG. 1C is a schematic illustration of the cutter clip of FIG. 1A when sealing an opened bag package;

FIG. 1D is a schematic illustration of the cutter clip of FIG. 1A in a closed position;

FIG. 2A is an expanded view of the cutter clip of FIG. 1A showing a blade station and a blade;

FIG. 2B is an expanded view of the clip with the blade and the blade station of FIG. 2A combined;

FIG. 3A is a schematic illustration of the cutter clip of FIG. 1A and a cross-sectional view of the blade installed in the clip;

FIG. 3B is a schematic illustration showing how the blade is held within the blade station;

FIG. 3C is a cross-sectional illustration showing an alternative embodiment of the blade installed in the clip;

FIG. 4a is a schematic illustration the cutter clip of FIG. 1A showing multiple alternative locations for the blade;

FIG. 4b is a schematic illustration the cutter clip of FIG. 1A showing another alternative location for the blade;

FIGS. 5A, 5B and 5C are schematic illustrations of the production of one embodiment of the cutter clip of FIG. 1; and

FIG. 6 is a schematic illustration an alternative embodiment of cutter clip of FIG. 1A showing a large slot in an inner wall of one of the arms.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The terms of “front”, “back”, “down”, “up”, “bottom”, “upper”, “horizontal”, “vertical”, “right”, “left” or any reference to sides or directions are used throughout the description for the sake of brevity alone and are relative terms only and not intended to require a particular component orientation.

Applicant has realized that adding a blade to the clip provides a clip which not only facilitates the opening of the bag packages, but also keeps the contents of the bag sealed after the package has been opened.

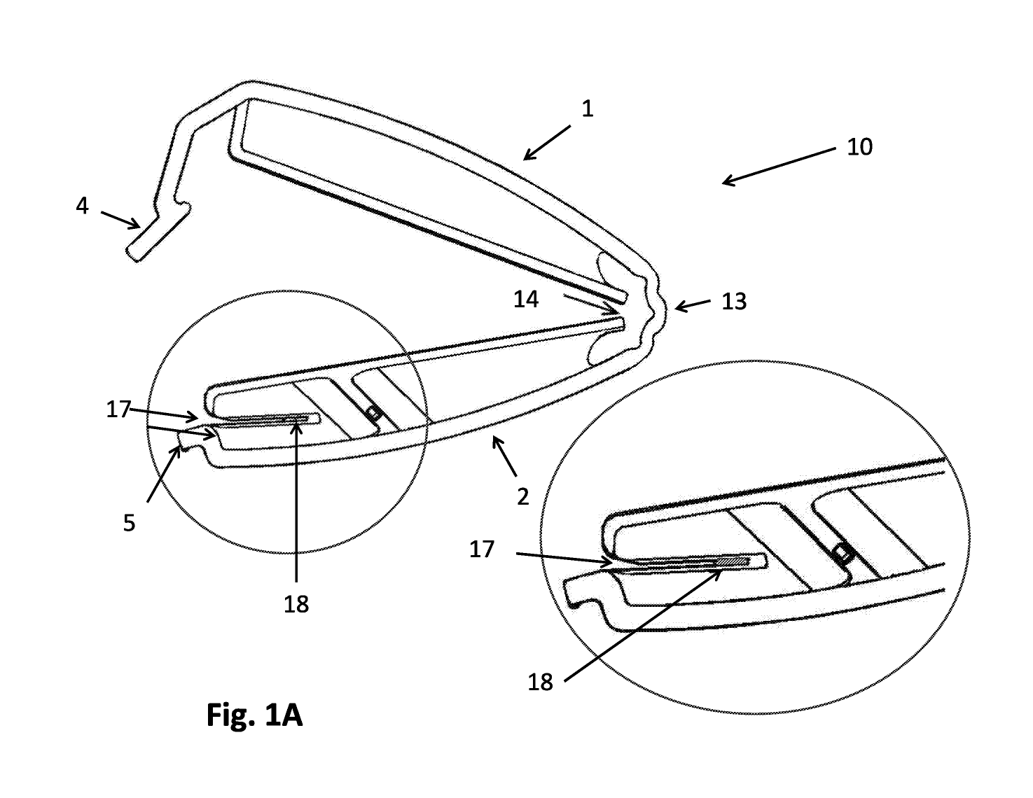

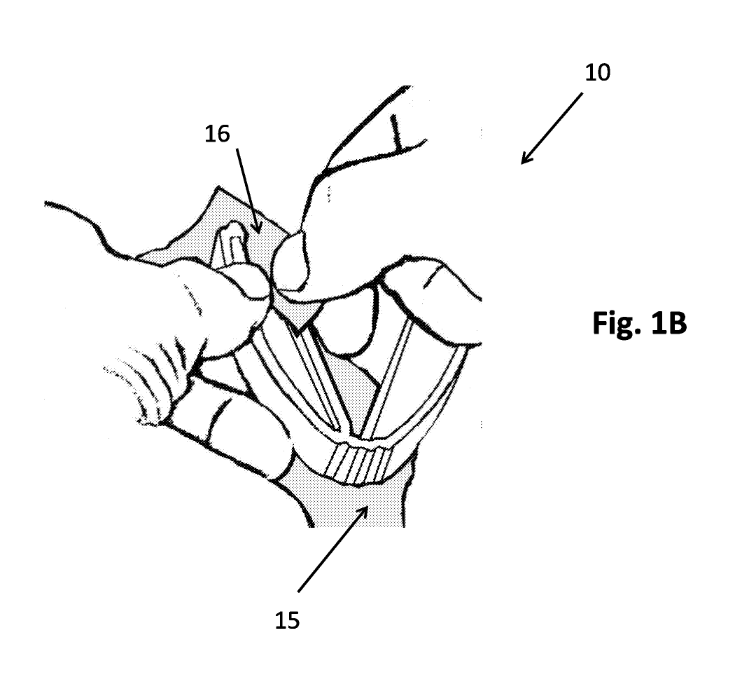

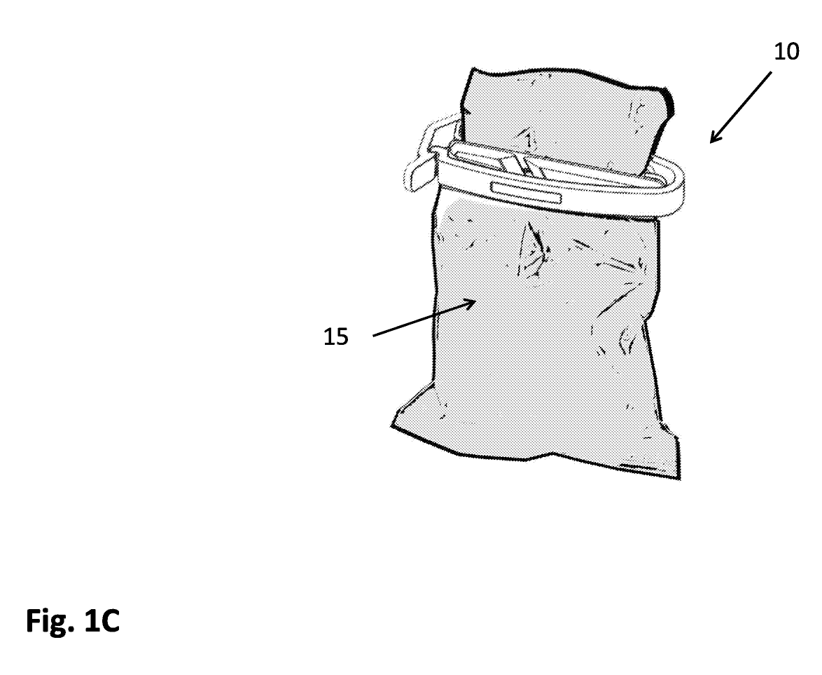

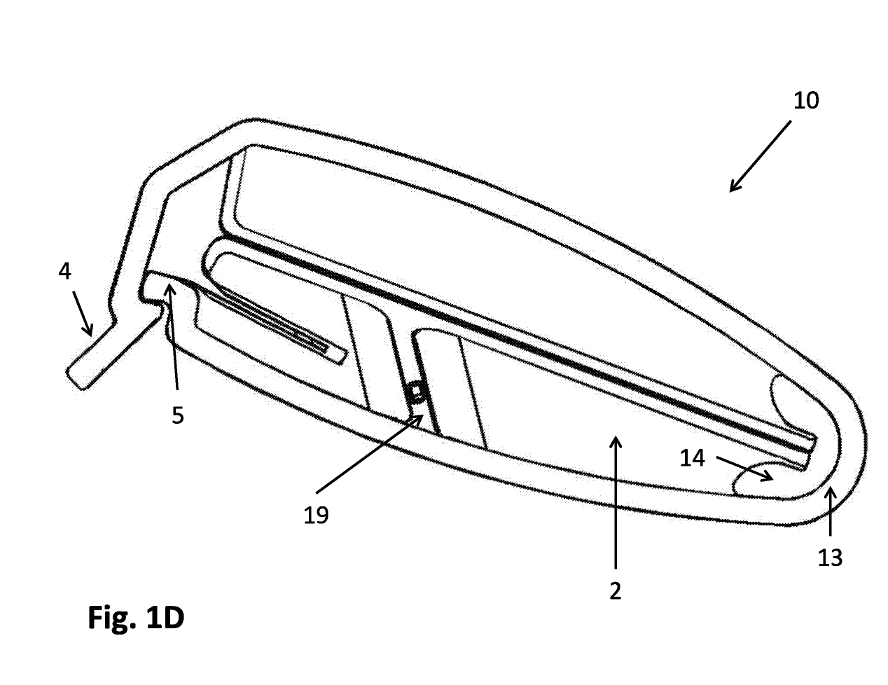

Reference is now made to FIG. 1A, which illustrates a side view of an opened cutter clip 10, constructed and operative in accordance with a preferred embodiment of the present invention, to FIG. 1B, which illustrates a user using cutter clip 10 to open a bag package 15, to FIG. 1C, which illustrates bag package 15 closed with cutter clip in a closed position and to FIG. 1D, which illustrates a side view of a closed position of the cutter clip 10.

As shown in FIG. 1A, cutter clip 10 may comprise a first arm 1, a second arm 2, an outer thick bow 13, and a blade 18. Bow 13 may be integrally connected to both first arm 1 and second arm 2 at their back ends, thereby providing a hinge between arms 1 and 2.

First arm 1 may comprise a clipping hook 4 at its front end and second arm 2 may comprise a closing hook 5 at its front end such that, to close cutter clip 10, a person may clip clipping hook 4 over closing hook 5. Closing hook 5 may hold clipping hook 4 in place while the cutter clip 10 is in a closed position, thereby preventing the opening of the cutter clip 10.

Thick bow 13 may have a thickness in the range of 0.5-5 mm, which may be thick enough to hold cutter clip 10 in a closed position and/or to minimize defects during use and manufacturing. In another embodiment, thickness in the range of 0.3-5 mm. In yet another embodiment, thickness in the range of 0.3-10 mm. Thick bow 13 may be a smooth bow or a ridged bow as shown and may provide additional flexibility to clip 10, particularly for thick bags.

In one embodiment, the cutter clip may have an integral thin hinge which connects the back ends of the first and second arms.

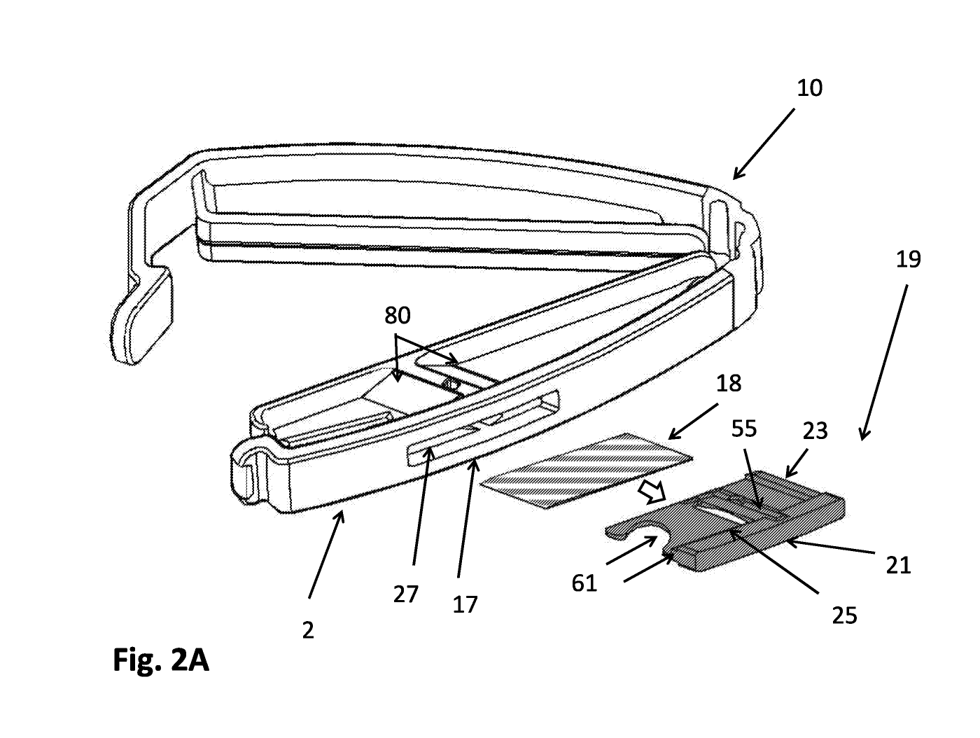

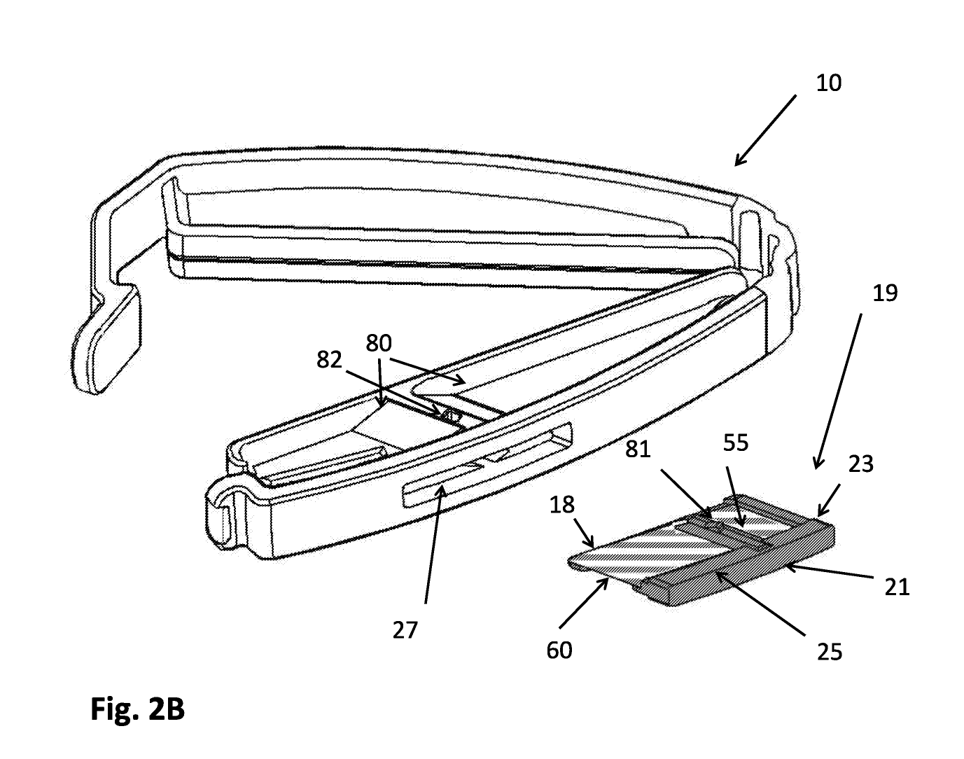

As mentioned hereinabove, cutter clip 10 additionally may comprise blade 18, partially shown in a close-up portion of FIG. 1A and shown in more detail in FIGS. 2A and 2B. Blade 18 may be held at an end of a long slot 17 formed in second arm 2. Long slot 17 may keep blade 18 in a protected location in cutter clip 10, to keep it from cutting fingers, slicing the package, etc.

As shown in FIG. 1B, the user may slide a closed edge 16 of package 15 through long slot 17 and against blade 18 in order to cut open package 15. Afterwards, the user may close cutter clip 10 on package 15, as shown in FIG. 1C.

FIG. 1D shows cutter clip 10 in its closed position. In this position, clipping hook 4 of first arm 1 hooks over closing hook 5 of second arm 2. Second arm 2 may press against the sides of long slot 17, pressing it closed and thus, covering blade 18 when it is not in use.

Reference is now made to FIGS. 2A and 2B which show blade station 19, blade 18 and clip 10 in an expanded view and in a combined view, respectively. As shown in FIG. 2A, blade station 19 may comprise an elevated outer wall 25, a side wall 23, a floor 21 and a flexible arm 55. During manufacturing, blade 18 may be slid onto floor 21 (FIG. 2B), under flexible arm 55 and snug up to walls 25 and 23. The blade station 19 may have a semi-circle shaped hole 61 upon which blade 18 may sit, thereby to enable blade 18 to come into contact with the bag and to leave blade 18 free for cutting.

The combination of blade 18 and blade station 19 may be placed into a wall slot 27 formed into second arm 2. Second arm 2 may also comprise sloping walls 80 which may be shaped to match flexible arm 55. Moreover, flexible arm 55 may include a protrusion 81 and sloping walls 80 may include a round slot 82 which may match protrusion 81, such that, when the combination of blade 18 and blade station 19 may be placed into wall slot 27, flexible arm 55 may bend until protrusion 81 may reach round slot 82, at which point, protrusion 81 may snap into round slot 82, thereby holding blade 18 in place.

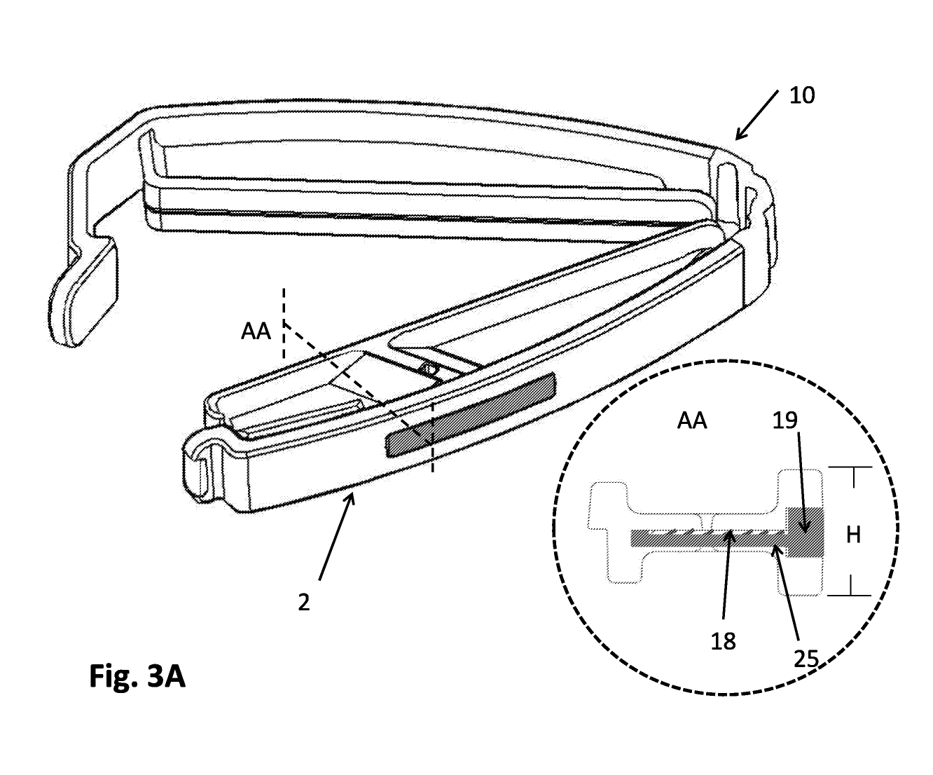

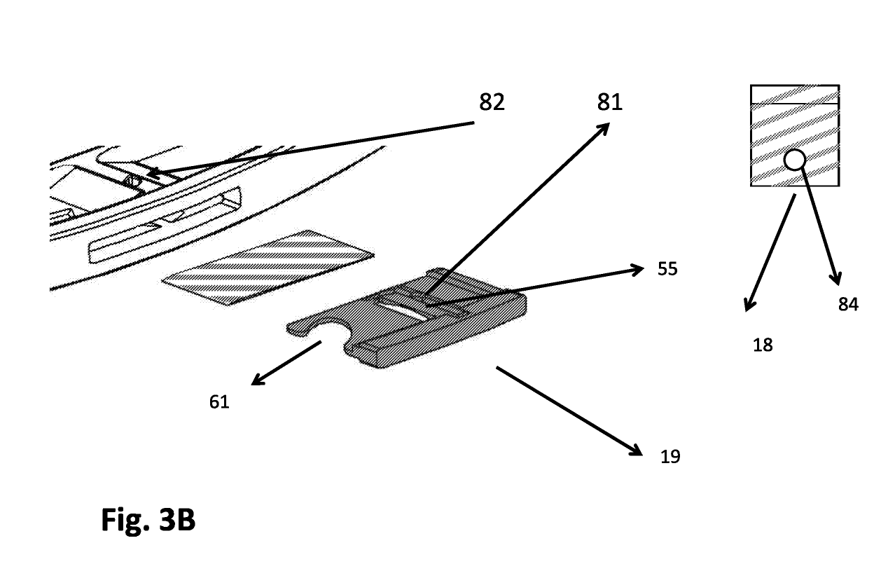

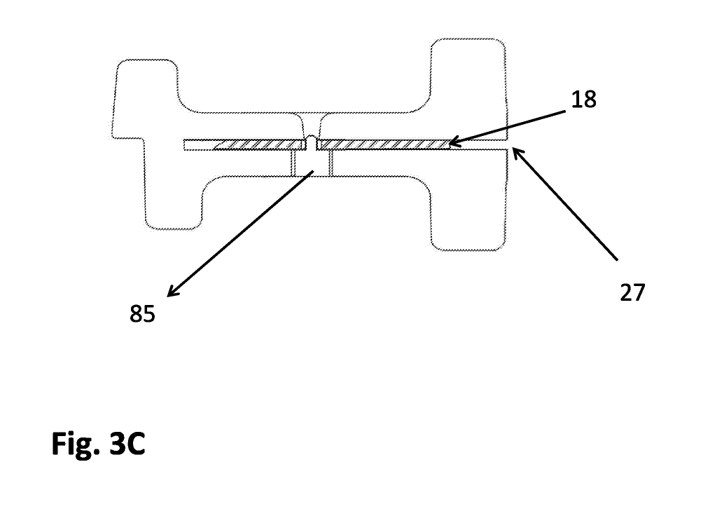

Reference is now made to FIG. 3A which shows cutter clip 10 with blade station 18 installed therein. Side wall 25 of blade station 19 may align along the side of second arm 2. FIG. 3 also shows a cross-sectional view of second arm 2, along line AA, showing how blade 18 is held within arm 2.

It may be appreciated that a height H of the outer walls of cutter clip 10 may be large enough to hold blade station 19 therein and may also be large enough to provide strength to outer bow 13.

Reference is now made to FIG. 3B, which is a schematic illustration of an alternative embodiment of the blade-station combination. In this embodiment, blade 18 may have a hole 84 therein which may match a downward protrusion (not shown) on flexible arm 55. Thus, when blade 18 may be slid under flexible arm 55, the downward protrusion of arm 55 may snap into hole 84 of blade 18, thereby holding blade 18 to station 19.

In a further alternative embodiment, shown in FIG. 3C to which reference is now briefly made, cutter clip 10 may have a protrusion 85 formed therein near slot 17, and blade 18, with hole 84, may slide into long slot 27 and may snap onto protrusion 85.

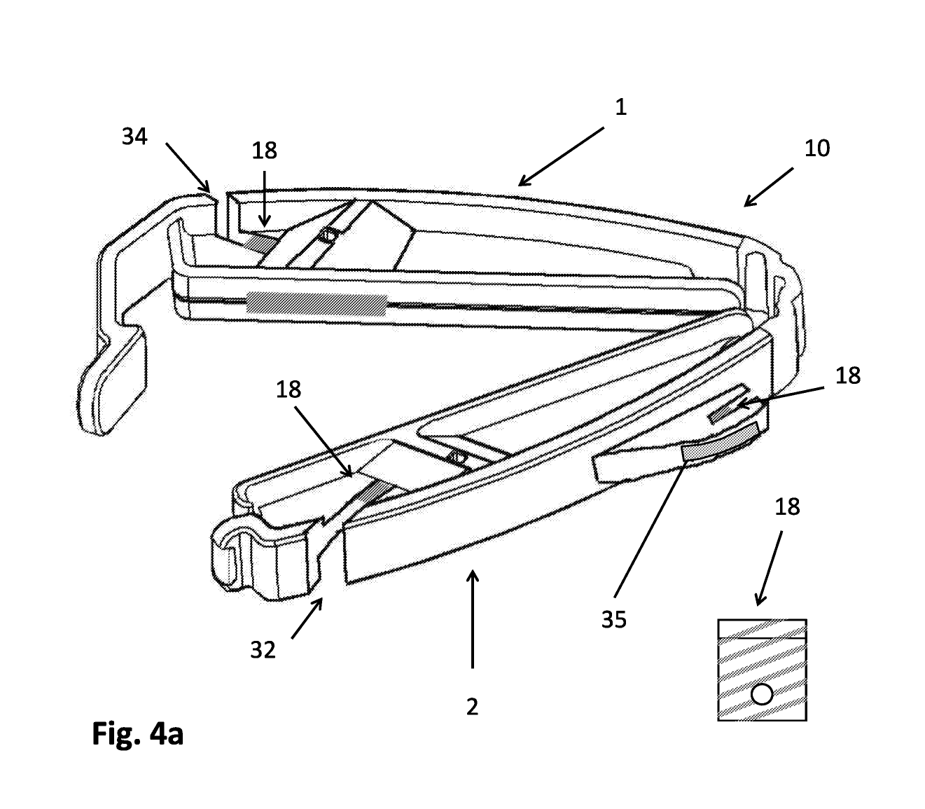

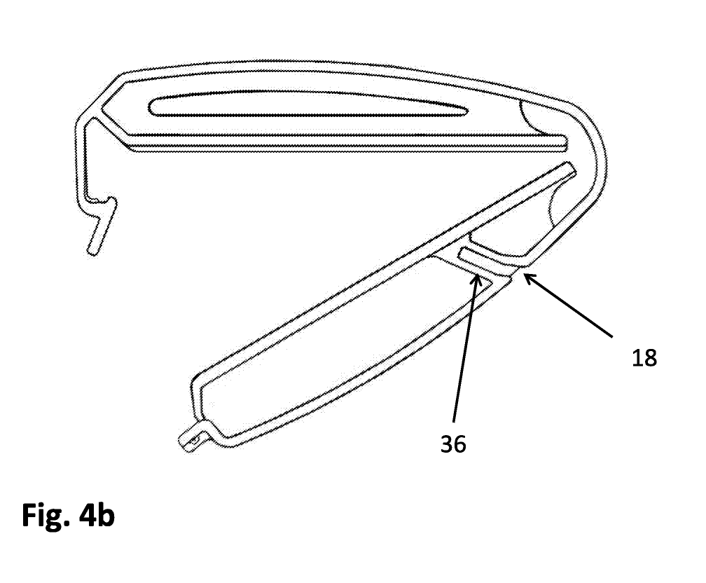

Reference is now made to FIG. 4a, which is a schematic illustration showing some alternative locations on arms 1 and 2 for long slot 17, through which a package may be brought to blade 18. Location 34 may be on the outside of first arm 1, near clipping hook 4. Location 32 may be on the outside of the second arm 2, near closing hook 5. Location 35 may be on the outside of second arm 2, near outer bow 13. In one embodiment, long slot 17 may be located on the inner side of the first arm 1. In another embodiment, long slot 17 may be located on the outer side of the first arm 1. In yet another embodiment, long slot 17 may be located on the inner side of the second arm 2. In yet another embodiment, long slot 17 may be located on the outer side of the second arm 2. It will be appreciated that long slot 17 may be located in any suitable location on clip 10 and at any angle.

Reference is now made to FIG. 4b, which is an illustration showing another alternative location for blade 18. Location 36 may be on the outside of second arm 2. It will be appreciated that blade 18 may be located in any suitable location on clip 10 and at any angle. In this embodiment, clip 10 may be manufactured with over molding, by injecting the plastic of the clip 10 around blade 18.

In an alternative embodiment, plastic may be injected directly onto the metal of blade 18 before placing it into blade station 19. In a further alternative embodiment, clip 10 may be manufactured with over molding, by injecting the plastic of the clip 10 around blade 18. In a further alternative embodiment, blade station 19 may be over molded around blade 18.

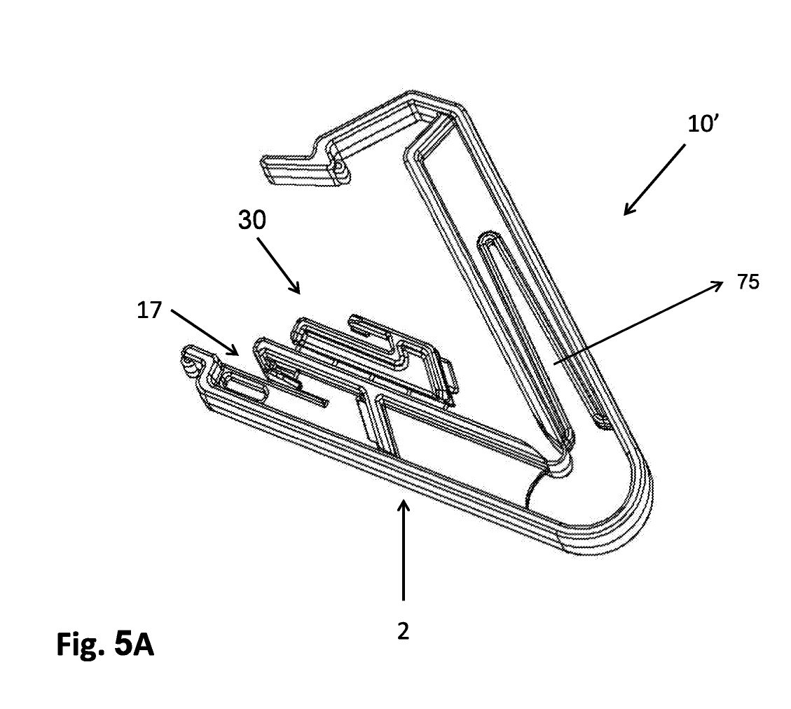

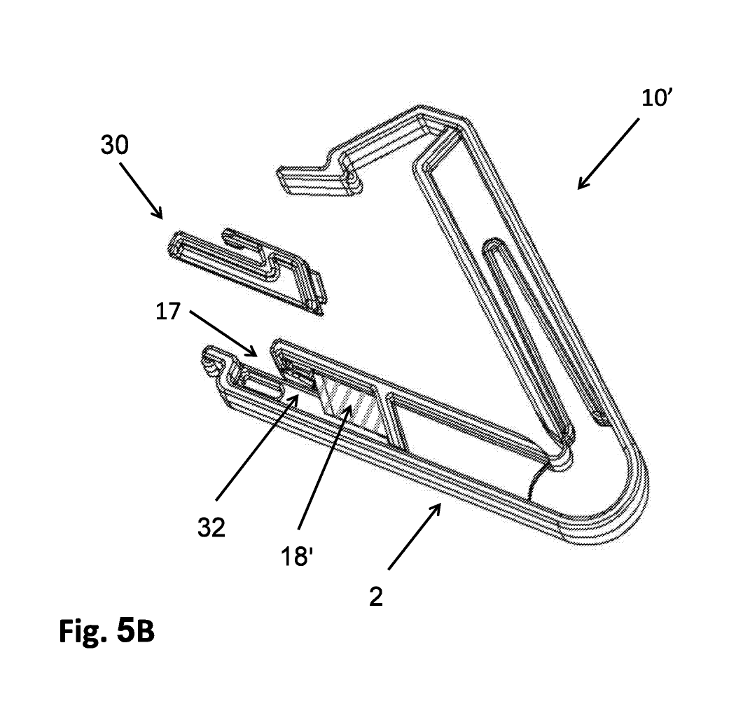

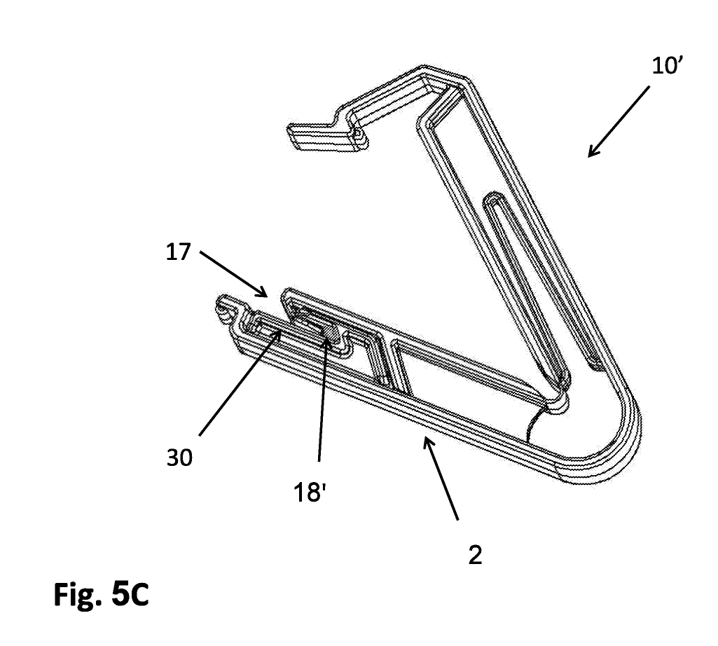

Reference is now made to FIGS. 5A, 5B and 5C which illustrate a further alternative embodiment of the cutter clip, here labeled 10′. In this embodiment, blade 18 may be a replaceable box cutter or utility knife type of blade, labeled 18′.

FIG. 5A shows cutter clip 10′ after molding, with blade covering 30 connected, through a thin plastic connection, to second arm 2. First arm 1 may be formed with a U-shape 75 which may contribute to the flexibility of first arm 1, thereby to enable it to bend more easily around thick bags. Cutter clip 10′ may also have one or two hinges for connecting the back end of first arm 1 to the back end of second arm 2. Each hinge may be connected to the inner walls or outer walls of the first arm 1 and second arm 2 at their back ends.

FIG. 5B shows replaceable blade 18′ being placed on a floor section 32 of second arm 2, with blade covering 30 disconnected from second arm 2.

In FIG. 5C, blade covering 30 is shown placed over replaceable blade 18′, thereby holding replaceable blade 18′ within second arm 2.

It will be appreciated that both second arm 2 and blade covering 30 have long slots 17 and that these slots 17 are aligned when blade covering 30 is placed over replaceable blade 18′.

To replace blade 18′, a user may remove blade covering 30, take out the existing blade 18′ and put in a new blade 18′.

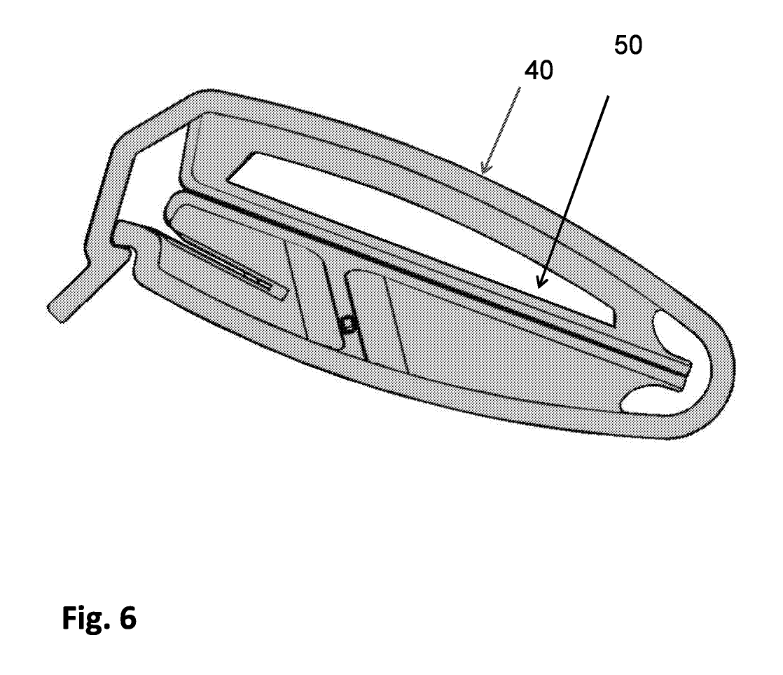

In an alternative embodiment, shown in FIG. 6 to which reference is now made, one of the arms, here labeled 40 may be formed with a large hole 50 therewithin. Large hole 50 may contribute to the flexibility of the inner wall of the arm, thereby to enable it to bend more easily around thick bags. The hole 50 may have close boundaries, as depicted in FIG. 6, or the hole 75 may have open boundaries as depicted in FIG. 5A.

In other embodiments the blade 18 may be inserted in a clip having a different design, shape or thickness. Thus, although the blade 18 has been illustrated in conjunction with a clip having a thick bow, the blade 18 may be inserted in other clip designs having different shapes and thicknesses.

In some embodiments more than the one blade may be inserted in a clip.

In one embodiment the clip may be manufactured with a cutting slot and without the blade. Hence a blade may be inserted at a later time. In this embodiment, the blade may be a utility knife type of blade, or any other type of blade.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A cutter clip for closing a bag package, said clip comprising:
a first arm having a clipping hook, at the front end, thereof;
a second arm, connected at its back side to the back side of said first arm, having a closing hook, at its front end, thereof, wherein said clipping hook closes on said closing hook, when said clip is in a closed position, for closing said bag package;
a cutting slot formed within said clip; and
a cutting blade, mounted within said cutting slot.

2. A clip according to claim 1, where an integral bow connects the back ends of the first and second arms along their outer walls.

3. A clip according to claim 2, where the bow has a thickness in the range of between 0.5-5 mm.

4. A clip according to claim 2, where the bow is a smooth bow.

5. A clip according to claim 2, where the bow is a ridged bow.

6. A clip according to claim 1 where a hinge connects the back ends of said first and second arms.

7. A clip according to claim 1 where two hinges connect the back ends of said first and second arms.

8. A clip according to claim 1, wherein the clipping hook, of the first arm, covers the blade when the hook is in the closed position.

9. A clip according to claim 1, where the cutting blade is installed within a blade station.

10. A clip according to claim 9, wherein plastic may be injected directly onto the metal of the blade before the blade is placed into the blade station.

11. A clip according to claim 9, wherein the blade station may be over molded around blade.

12. A clip according to claim 1, wherein the clip may be manufactured with over molding, by injecting the plastic of the clip around the blade.

13. A clip according to claim 1, where the blade is removable.

14. A clip according to claim 1, wherein the blade is a utility knife type of blade.

15. A clip according to claim 1, wherein the blade is located on the first arm.

16. A clip according to claim 1, wherein the blade is located on the second arm.

17. A clip according to claim 1, wherein at least one of the arms, has a hole therewithin.
